(19) United States
(12) Patent Application Publication
(10) Pub. No.: US 2025/0119872 A1
(43) Pub. Date: Apr. 10, 2025

(54) TECHNIQUES FOR RADIO-BASED SENSING

(71) Applicant: Lenovo (Singapore) Pte. Ltd., Singapore (SG)

(72) Inventors: Seyedomid Taghizadeh Motlagh, Oberursel (DE); Prateek Basu Mallick, Dreieich (DE); Genadi Velev, Darmstadt (DE)

(21) Appl. No.: 18/907,211

(22) Filed: Oct. 4, 2024

Related U.S. Application Data
(60) Provisional application No. 63/588,643, filed on Oct. 6, 2023.

(51) Int. Cl. H04W 68/02; H04W 48/10; H04W 76/27

(52) U.S. Cl. CPC H04W 68/02; H04W 76/27; H04W 48/10

(57) ABSTRACT

Various aspects of the present disclosure relate to techniques for radio-based sensing. An apparatus is configured to receive a paging radio network temporary identifier (P-RNTI) for receiving a paging message associated with sensing, receive information associated with paging occasions (POs) to be monitored that are associated with the P-RNTI, receive a paging message based on the received P-RNTI and the information associated with the POs, determine sensing suitability of the UE based on the received paging message, and transmit a request to transfer to radio resource control (RRC) connected state based on the determined sensing suitability.

### TECHNICAL FIELD

The present disclosure relates to wireless communications, and more specifically to techniques for radio-based sensing.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further receive a paging radio network temporary identifier (P-RNTI) for receiving a paging message associated with sensing, receive information associated with paging occasions (POs) to be monitored that are associated with the P-RNTI, receive a paging message based on the received P-RNTI and the information associated with the POs, determine sensing suitability of the UE based on the received paging message, and transmit a request to transfer to radio resource control (RRC) connected state based on the determined sensing suitability.

Some implementations of the method and apparatuses described herein, may further receive a request for at least one sensing task, determine, in response to the request, a paging message, the paging message comprising suitability criteria for sensing, a sensing measurement configuration, or a combination thereof, transmit the determined paging message, and receive a response comprising a sensing suitability, sensing data availability, or a combination thereof.

### BRIEF DESCRIPTION OF THE DRAWINGS

FIG. 1 illustrates an example of a wireless communications system in accordance with aspects of the present disclosure.

FIG. 2 illustrates one embodiment of examples of radio sensing scenarios in accordance with aspects of the present disclosure.

FIG. 3A illustrates a tight coupling integrated sensing and communication (ISAC) network architecture in accordance with aspects of the present disclosure.

FIG. 3B illustrates a tight coupling ISAC network architecture with CP/UP split in accordance with aspects of the present disclosure.

FIG. 3C illustrates a collocated ISAC network architecture in accordance with aspects of the present disclosure.

FIG. 3D illustrates a loose coupling ISAC network architecture in accordance with aspects of the present disclosure.

FIG. 4 illustrates an example sequence of multiple suitability criteria in accordance with aspects of the present disclosure.

FIG. 5 illustrates an example of monitoring paging occasions for sensing paging of UEs with different conditions in accordance with aspects of the present disclosure.

FIG. 6 illustrates an example of a UE 300 in accordance with aspects of the present disclosure.

FIG. 7 illustrates an example of a processor 400 in accordance with aspects of the present disclosure.

FIG. 8 illustrates an example of a network equipment (NE) 500 in accordance with aspects of the present disclosure.

FIG. 9 illustrate a flowcharts of method performed by a UE in accordance with aspects of the present disclosure.

FIG. 10 illustrate a flowcharts of method performed by a NE in accordance with aspects of the present disclosure.

### DETAILED DESCRIPTION

Radio-based environment sensing impacts cellular wireless networks, both as a mechanism to improve network performance, as well as an enabler to serve vertical use-cases. In 3GPP SA1 TR 22.837 (incorporated herein by reference), multiple use-cases of sensing information is agreed wherein the sensing information is obtained (and exposed to the requesting entity) by the wireless communication network. As such, a radio sensing measurement process intends to generate and collect measurements to obtain sensing information of the target objects/environment and/or the involved radio nodes (information of position, velocity, direction/heading, orientation, radar cross section (RCS), shape, material/composite etc. of an object and/or a radio node), by means of combination of the one or multiple of transmission of a sensing signal, e.g., a sensing reference signal (RS), from a network or UE entity, hereafter termed as sensing Tx node; reception of the reflections/echoes of the transmitted sensing excitation signal from the environment by a network or a UE entity, hereafter termed as sensing Rx node; processing of the received reflections and inferring relevant information from the environment. The sensing measurement process may include one or multiple (static or mobile) sensing Tx nodes and one or multiple (static or mobile) sensing Rx nodes.

In this respect, scenarios of UE-assisted sensing, where a UE device participates in the sensing measurement process as a sensing Tx, sensing Rx, or supports the sensing process as a non-3GPP sensing information provider, may be motivated by several agreements of 3GPP SAI TR 22.837, e.g., UCs 5.9, 5.10, 5.12, 5.15, 5.17, 5.19, 5.32, etc. (incorporated herein by reference). In this regard, and considering the inactivity/idle state of a UE with a high probability (e.g., the available/capable sensing UE devices may not be in the RRC active state when needed by a sensing task/operation), in this disclosure, solutions are disclosed for problems that arise with querying a UE regarding the UE's sensing capability and/or available sensing and how the UE may react and provide a response to the network based on the UE's determination of their capability for sensing (based on received criteria in the request), where a UE (or a group of UEs) are in an RRC inactive or RRC idle state and where one or multiple of the UEs are capable of performing sensing transmission/reception/measurement according to a sensing task description or own useful sensing information.

Aspects of the present disclosure are described in the context of a wireless communications system.

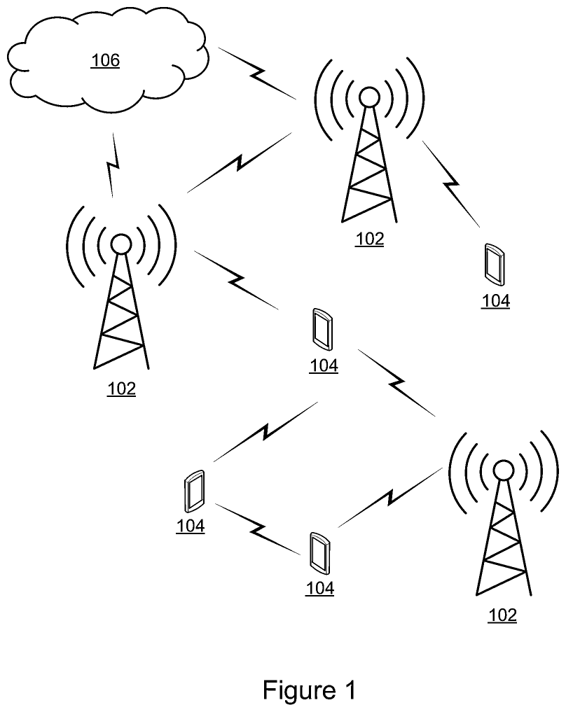

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., p=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz- 300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

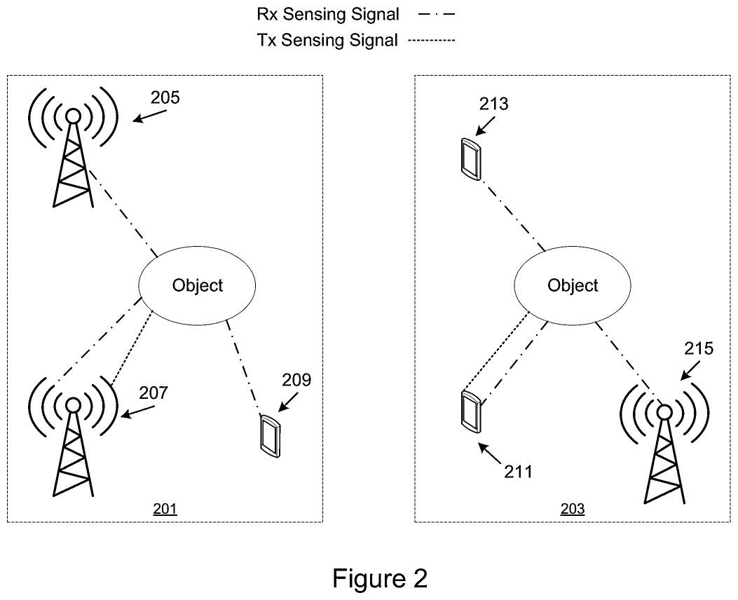

FIG. 2 depicts one embodiment of examples of radio sensing scenarios. In one embodiment, the network configures the participating sensing entities, e.g., network and UE nodes acting as sensing Tx nodes and sensing Rx nodes, as well as the configuration of sensing RS and necessary measurements for sensing data and reporting procedures to provide sensing results. In this regard, the functional split between the network and the UE nodes for a specific sensing task may take various forms, depending on the availability of sensing-capable devices and the requirements of the specific sensing operation.

In the first three scenarios 201, the network is the Sensing Tx.

In the first scenario 205, the Sensing Tx and Sensing Rx are separate radio access network nodes. In this case, the sensing RS (or another RS used for sensing, or the data/control channels known to the network TRP nodes) is transmitted and received by different radio network entities.

In the second scenario 207, the Sensing Tx and Sensing Rx are the same radio access network node. The sensing RS (or another RS used for sensing or the data/control channels known to the network TRP nodes) is transmitted and received by the same radio access network entity.

In the third scenario 209, the Sensing Tx is a radio access network node and the Sensing Rx is a UE. In this case, the sensing RS or other RS used for sensing is transmitted by a radio access network entity and received by one or multiple UEs. The network selects and/or configures the UEs to act as a sensing Rx node, according to the UE capabilities for sensing, as well as with respect to the desired sensing task.

In the final three scenarios 203, the UE acts as the Sensing Tx.

In the fourth scenario 211, the Sensing Tx is a UE and the Sensing Rx is a radio access network node. In this case, the sensing RS or other RS used for sensing (or a data/control channel transmitted by the UE) is received by one or multiple network entities and transmitted by a UE. The network selects and/or configures the UE to act as a sensing Tx node, according to the UE capabilities for sensing, as well as the nature of the desired sensing task.

In the fifth scenario 213, the Sensing Tx is a UE and the Sensing Rx is a separate UE. In this case, the sensing RS or other RS used for sensing is received by one or multiple UEs and transmitted by a single UE. In this case, the network, or a UE, may potentially decide the selection and/or configuration of the sensing scenario. In one scenario, the network selects and/or configures the UEs to act as sensing Tx and/or sensing Rx nodes, according to the UE capabilities for sensing, as well as the nature of the desired sensing task. In another scenario, a UE may also participate in the selection and configuration of the sensing nodes.

In the sixth scenario 215, the Sensing Tx and Sensing Rx are the same UE. In this case, the sensing RS (or another RS used for sensing, or the data/control channels known to the UE) is transmitted and received by the same UE. In this case, the UE or the network selects and/or configures the sensing service, according to the UE nodes capabilities for sensing, as well as the nature of the desired sensing task.

The above scenarios are not intended to be restricted to a specific UE type and may include any UE category. In any of the above scenarios, and of the roles elaborated for gNB and/or UE may be replaced (with equal validity for any example of a radio sensing scenario) with any UE or RAN node, e.g., a smart repeater node, an integrated access and backhaul (IAB) node, a roadside unit (RSU), or the like. In some examples, the set of Sensing Tx nodes of a sensing measurement process (and similarly, but may be independently, a sensing Rx nodes of a sensing measurement process) include one or more of a TRP associated to a gNB-centralized unit (CU)/distributed unit (DU), a gNB-DU, a gNB-CU, a UE, a network-controlled repeater (NCR), an IAB node, an RSU, or a dedicated sensing radio. In some embodiments, a sensing Rx node may be a non-3GPP sensor with the capability of providing non-3GPP sensing data, or a 3GPP node (e.g., a UE or a RAN node) connected to the non-3GPP sensor and can obtain, process, and transfer the non-3GPP sensing data of the said non-3GPP sensor to other 3GPP nodes/entities.

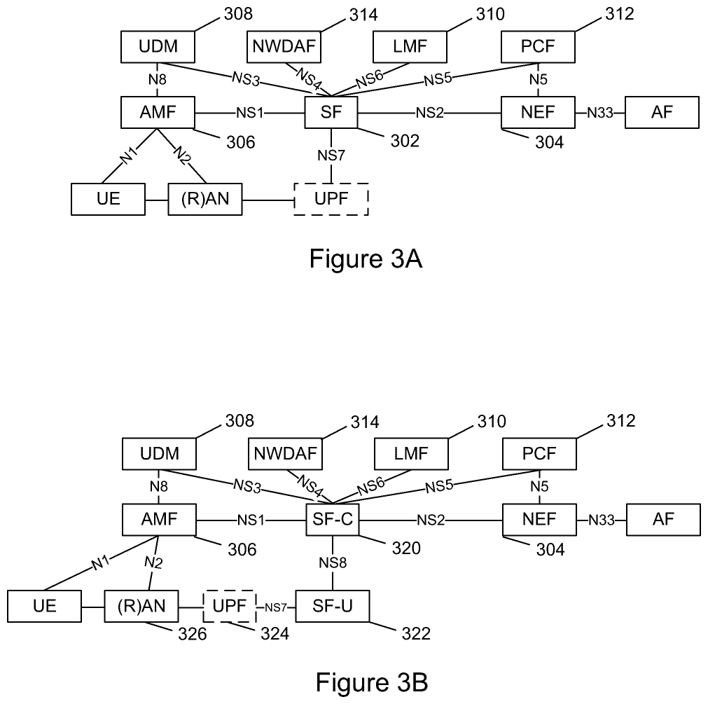

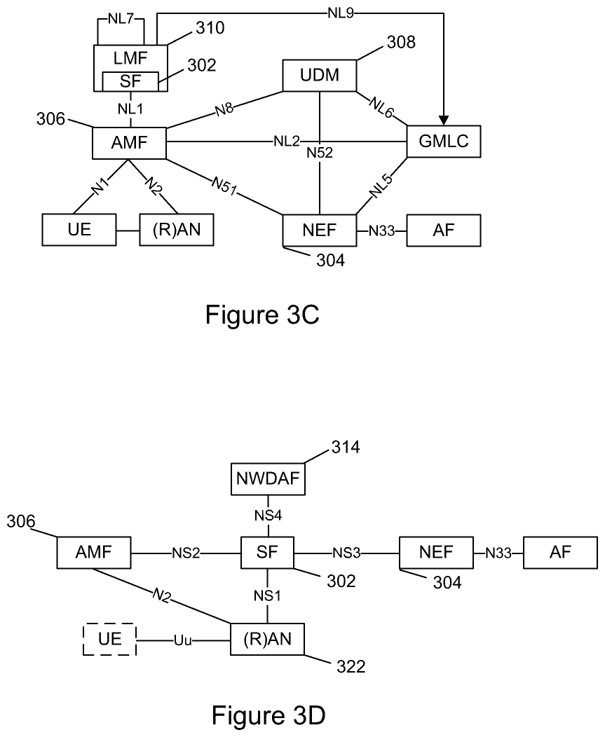

Integrated sensing and communication may enhance 5G core architecture by introducing a new Sensing Function (SF). FIGS. 3A-3D depict examples of possible combinations leading to the network impact. As shown in FIGS. 3A-3D, four proposals for enhancing the 5G core by introducing a SF as a dedicated or logical Network Function (NF) are considered, including the following architecture flavors.

In a first scenario shown in FIG. 3A, a tight coupling ISAC network architecture is shown where the SF 302 appears as a dedicated NF handling both: (i) the sensing control plane aspects such as the interaction with the sensing consumer via Network Exposure Function (NEF) 304 and information exchange with other NFs, for gathering UE information, (e.g., from the Access and Mobility Management Function (AMF) 306, Unified Data Management (UDM) 308, Location Management Function (LMF) 310, UE related policies from the Policy Control Function (PCF) 312, and analytics from the Network Data Analytics Function (NWDAF) 314) and (ii) the sensing radio signals for performing the analysis or prediction for determining the sensing target.

In a second scenario shown in FIG. 3B, a tight coupling ISAC network architecture with CP/UP split where the SF 302 has two dedicated NF counter parts: (i) SF-C 320 that handles the control plane aspects as described above and (ii) SF-U 322 that is responsible for collecting the sensing radio signals via the user plane, e.g., via the Radio Access Network (RAN) 326 and User Plane Function (UPF) 324. The idea of this architecture is to split and offload heavy data volumes associated with sensing radio signals to the user plane to ensure light traffic, e.g., only singling, in the control plane.

In a third scenario shown in FIG. 3C, the SF 302 is collocated with the LMF 310 and appears as a logical NF embedded in the LMF 310 to perform sensing taking advantage of the knowledge of a UE location.

In a fourth scenario shown in FIG. 3D, a loose coupling ISAC network architecture where the SF is independent of the 5G core, e.g., typically used for local field scenarios or private networks, and the interaction with the 5G core is minimal. The main idea is to use SF 302 close to the RAN 322, e.g., collect and process the sensing radio signals locally, and interact with 5G core for the purpose of exposure via NEF 304, for getting the UE location from the AMF 306 and for analytics (NWDAF 314).

In another description of controlling a sensing operation, in some example implementations, a sensing controller entity/function (SensMF) is defined that comprises one or multiple of a UE, a RAN node, a gNB/gNB-CU, an LMF, an SF, or a combination thereof, wherein the SensMF performs one or multiple of (a) receiving request for sensing information from a service consumer (e.g., a requesting third party application); (b) determining selection and/or configuration of a sensing operation, including configuration of one or more of a sensing Tx node, sensing Rx node; (c) selecting and/or configuring the involved nodes for sensing transmission and sensing reception and sensing measurement and reporting of the conducted measurements; (d) collecting the sensing measurements; (e) performing or configuring or requesting computation of the sensing measurements and thereby determining the required sensing information based on the obtained sensing measurements; and/or (f) reporting/exposing obtained sensing information to the entity requesting the sensing information.

In some examples wherein the SensMF is comprised of multiple nodes/entities, one portion of the above-mentioned steps (a)-(f) may be implemented by the first part of the SensMF and the second portion of the above steps may be implemented by the second part of the SensMF, e.g., implemented in the SF and gNB.

In some examples wherein the SensMF is comprised of multiple nodes/entities, the communication among the SensMF entities are transparent to the outside entities and also not discussed in the related handover (HO) procedure embodiments; nevertheless, the communication among the SensMF entities are assumed to be implicit to the overall procedure.

In some examples, wherein a SensMF is comprised of an SF and a gNB (e.g., serving/head gNB of a related UE to the sensing task or a selected serving gNB for a sensing task), the SF performs the steps (a), (f), (e), (d) whereas the steps (b), (c) are performed by the selected gNB node. In some other embodiments, the step (b), (d) are jointly performed by the SF and the selected gNB, wherein a first part of the configuration/configuration determination are performed by the SF and a second part of the configuration/configuration determination is performed by the selected gNB. The SensMF may be a RAN node (e.g., a selected gNB node acting as serving gNB of a sensing task), may be a sensing function (SF) residing in core network, may be a UE, or a combination thereof.

It is understood that this disclosure is not limited to any of the single example/solution/embodiments or implementation elements individually, and one or more elements of the above-mentioned may be combined to construct a new embodiment.

In one embodiment, this disclosure introduces and utilizes the proposed paging for sensing. However, it is understood that other elements of the proposed solutions/embodiments (e.g., without step of transmission of a paging) may act as a standalone embodiment/solution, as intended by the current disclosure, and wherein the paging of a UE shall be interpreted as one (nonexclusive) instance of finding/selecting/discovery of UE (which is hence not limited to the exemplified paging-based discovery instances).

In one embodiment, the non-3GPP sensing measurement/data is intended to be interpreted as a related sensing data obtained via a RAT-independent mechanism and is not restricted by any interpretation of being of non-3GPP nature.

In one embodiment, a SensMF (e.g., a sensing-dedicated core network function SF, an (extended) LMF, or a sensing controller residing in RAN) receives sensing request(s) for one or multiple sensing tasks, wherein the one or multiple sensing tasks may include a description of one or multiple sensing targets and/or sensing target areas of interest from one or multiple sensing client/consumers, which share at least, among others, a location information associated with the sensing task, known herein as a location of interest or “Loci.” In one embodiment, the Loci may include an initial location of a sensing target, a potential location of a sensing target upon presence, an area of interest to be monitored via sensing, a description of a moving sensing target area, or the like.

In one embodiment, SensMF determines one or more radio network elements providing cellular coverage in and around the Loci. In some examples, this can be done with the help of operations and maintenance (O&M) to have a mapping between geographical areas and radio network identity like for gNB identity. A request and/or configuration for sensing may then be sent to the respective gNB(s) in and around the Loci. According to this embodiment, one or more of the involved gNBs of a sensing task may transmit paging messages for the RRC Idle and/or inactive UEs, wherein the paging messages may include an indication of a sensing request (for sensing measurements, sensing information/data) and/or a query (e.g., a criteria for a desired sensing capability, etc.). Subsequently, UEs capable of participating in the sensing measurement process of the one or multiple sensing tasks (as sensing Tx/Rx node) or capable of providing sensing information (e.g., non-3GPP sensing data) may accordingly react and/or respond to the paging message.

According to one embodiment, SensMF determines the location/area, gNB/TRPs by which the paging message is to be transmitted, one or multiple UEs (in case paging of the UEs includes indication of a specific one or multiple UEs) or a UE group to be paged, information contained in the paging message, or a combination thereof, at least in part, based on the received description of one or more sensing tasks and/or based on the assisting information received for the associated said one or more sensing tasks.

In some embodiments, the SF receives one or more UE IDs or a UE group ID or a UE description (e.g., potential location, capability information, etc.) or a combination thereof as part of an assisting information of a sensing task from a sensing client, wherein the UEs associated to the said UE IDs (or the UE group) are indicated as (one or more of) (a) potential candidates for participating in a sensing operation (e.g., as a sensing Tx and/or sensing Rx nodes); (b) as potential sources of non-3GPP sensing data/measurements (e.g., via WiFi sensing measurement or configuration data, camera data, or the like); (c) as reference points for a mobile sensing target area, wherein the sensing area of interest to be sensed/monitored is defined in relation to the position information, pose information, velocity direction, orientation of the UE (to observe a blind spot of a car as an indicated UE), or the like; (d) as notification destinations for a sensing result, wherein upon determination of a requested sensing information/result the indicated UEs are notified and/or informed of the sensing results. In one example, when an intruder is detected as a sensing result of a sensing task, the UE/UE ID indicated within the sensing task as notification destination of the sensing result/task is paged and informed of the detected intruder. In another example, when an area is sensed that is known by the network to be associated to a UE, the UE is paged and informed of the sensing operation (and/or the sensing results); and (e) as notification destinations for a sensing operation wherein upon performing a sensing operation (sensing transmission, reception, non-3GPP sensing measurement) at a particular target area and/or at a particular time, the one or more UEs that are indicated by the consumer as the sensing operation notification destination are notified and/or informed of the presence of the sensing operation and/or the sensing operation type.

As such, the SensMF may initiate/request a paging procedure for the UEs. In some embodiments, when the sensing task further includes an area of interest (e.g., a Loci) for sensing and/or notification, the paging message to the one or more UE IDs is further restricted to the gNB/TRPs associated to the area of interest (e.g., an indicated UE ID is paged within the indicated area).

In some embodiments, the paging of UEs for participating in a sensing task (e.g., as a sensing Tx node or sensing Rx node) is performed upon a determination (e.g., by the SF, the gNB controlling a sensing task/operation, NWDAF, the SensMF, or a combination thereof) that UE participation in a sensing task is required (e.g., since the sensing task cannot be accomplished by the available/capable sensing Tx/Rx nodes of the RAN and/or an associated sensing task may allow (e.g., considering security concerns or protection of the sensing features involved in the said sensing task) UEs to act as a sensing Tx node and/or sensing Rx node and/or sensing measurement/processing node).

In some embodiments, the SF further determines, at least in part, the content of the paging message, e.g., one or more of a criteria, measurement configurations, sensing request, etc. In some embodiments, the SF/SensMF determines and/or recommends if the paging message transmission is needed and/or the content of the paging message, based on the description of one or more sensing tasks (e.g., KPI, the sensing area, or the like) and the available capability and/or radio resources of the RAN nodes for sensing (e.g., available TRPs at a sensing area capable of sensing and the available/possible sensing resources).

In some embodiments, the SF/SensMF, upon indication of one or more sensing task descriptions (sensing type, e.g., detection and positioning of a sensing target, sensing area, sensing KPI, etc.) to an analytics function defined within the NWDAF, receives recommendations of the gNBs/gNB-TRPs/UEs to be used for sensing from the analytics.

In another example, NWDAF provides recommendations that if, for a sensing area of the one or more sensing tasks, UE sensing assistance (e.g., UE as sensing Tx/Rx, or non-3GPP sensing data source) is needed/desired and/or by which TRP a paging message shall be sent, the criteria, occasion, and request/query embedded within the paging message (or a combination thereof). In some embodiments, the determination of the paging transmission, paging transmission occasion, paging message content, or a subset or combination thereof is determined (at least in part) by the AMF and/or communicated to the involved RAN nodes by the AMF, upon reception of a request and/or recommendation by the SF or SensMF.

In some embodiments, the determination by the SF of which gNB/TRPs shall be selected for the paging message is done based on the communication with O&M (wherein O&M may indicate to the SF which gNB/TRPs are related to a desired sensing task/area and/or may support sensing and/or UE assisted sensing).

In some embodiments, the paging of one or more UE IDs include an indication of a UE group ID within the paging message that is sent towards a known/indicated group of UEs.

In some embodiments the paging message transmission towards a UE or group of UEs is performed upon determination that the said UE, or all or part of the said group of UEs, or sufficient number of UEs (e.g., sufficient number of the UEs as sensing Tx and/or sensing Rx node according to the SensMF determination) are not available in the RRC active state.

In some embodiments, the SF determines a serving gNB of a sensing task, the paging message and occasion/transmission (e.g., if a paging message shall be sent and the content of the message) is determined by the serving gNB of the sensing task (and may be communicated with the gNB TRPs of other gNBs via the X2 interface), based on the description of the one or more sensing tasks, the available radio resources, 3GPP/non-3GPP sensing data, available RAN nodes (TRPs) capable of participating in the associated one or more sensing tasks, the recommendation of the SF or NWDAF (e.g., on the need for UE assisted sensing and/or the type/description of UE assisted sensing), or a combination thereof.

In some embodiments, SF may make decisions for sensing paging after negotiating with the AMF, e.g., the SF determines that UE-based sensing is needed to associate to one or multiple sensing tasks; the SF asks AMF and/or LMF for UEs present location within an area; upon the AMF receiving the request, the AMF determines the UEs in the RRC active state and within the area, e.g., by sending a query towards the potential UEs within the area in the active state) and report the obtained UE IDs or UE descriptions to the SF; based on the AMF response and the identified need by the SF, the SF recommends/decides transmitting a paging message for sensing node discovery. In some alternate embodiment, the AMF may jointly send a query to the active UEs within the area and (determine) to send a paging message towards the inactive/idle UEs within the area.

In some embodiments the determination of a sensing paging includes transmitting a broadcast/groupcast message towards active UEs that includes one or multiple of the criteria as described herein, and wherein the paging transmission and the content is determined subsequently.

In the embodiments described herein, the SF/SensMF determining of a paging message may be done interchangeably at the AMF, at the LMF, at a gNB serving a sensing task, or a combination thereof, and the cases of SF determining the paging message are given as an example, e.g., SF may determine a sensing paging message, or SF may request the AMF or a gNB of the UEs within a sensing area with one or more criteria and the AMF/gNB may determine to transmit a paging message to obtain the requested information by the SF.

In some embodiments, SensMF (e.g., a selected serving gNB of a sensing task by the SF, or the SF, when sensing operation is controlled/configured by a core network function) upon receiving sensing request for a particular area determines which TRP or DU is serving that area. Furthermore, the SensMF further determines if the UEs in RRC idle and inactive state shall be paged within an area (e.g., upon determination that the available TRPs capable of sensing, and/or radio resources available to TRPs for sensing and/or the available UEs in RRC active state, which are capable of a sensing operation are not sufficient to perform the desired sensing operation, upon determination that the UEs within a given area may inform the SensMF of one or more sensing/environment information that may be useful for the said sensing task). Upon this determination, RRC Idle and Inactive UEs in the area may be paged.

In some embodiments, the new-paging (sensing paging) messages are indicated by a specific P-RNTI reserved for this purpose and is carried within the DCI. Only UEs capable and ready to perform a sensing operation receive the new-Paging e.g., other UEs are not trying to decode physical downlink control channel (PDCCH) using the reserved P-RNTI. In response to detecting a DCI, the UE demodulates and decodes the corresponding physical downlink shared channel (PDSCH) to extract the new-paging message(s).

In one embodiment, the new paging may include one or more sensing suitability criteria. The sensing suitability criteria may include (a) Loci and a radius from Loci, where an RRC Idle/Inactive UE will determine its current location and thereafter determine if it is within a distance less than or equal to the received radius from the Object; (b) Stationarity conditions (e.g., the UE determines a stationary condition based on the estimated UE speed and an indicated threshold within the paging message/PE); (c) 3GPP/radio sensing capability where the UE determines if it is capable of the sensing operation, e.g., based on an indicated capability within PE the (e.g., sensing transmission capability, sensing reception/measurement capability, a joint transmission and reception capability, e.g., for an indicated RS configuration within the PE); (d) UE has sufficient UE battery available (according to an indicated threshold); (e) UE's radio geometry e.g., DL reference signal received power (RSRP)/Q of the serving cell are better than a certain threshold; (f) UE has a tight time/clock synchronization with respect to DL of the serving cell or to GNSS; (g) UE can fulfil required sensing quality as received in the paging message/PE (e.g., supported max. bandwidth, max time window for sensing, supported measurement types etc.); (h) fulfils indicated role/criteria as received in paging message criterion based on UE measurements of an RS or a sensing signal according to the received sensing configuration within the paging message, e.g., the UE performing measurement based on the received measurement configuration within the paging message and based on the performed said measurements and the criteria embedded within the paging message (e.g., a configured reference signal received power path (RSRPP) measurement exceeds an indicated threshold within the PE), the UE determines the sensing suitability; (i) if UE has information of the physical characteristics (e.g., type (e.g., human/car), size (volume, surface, etc.), dimensions, shape, RCS information) of the physical objects attached to, close to, or surrounding the UE, e.g., a person holding a UE, a vehicle physical body attached to a UE, a container that carrier a UE, or a vehicle or a metallic object in a close vicinity of a UE; (j) one or more criteria of the above information on physical characteristics (e.g., of an object size/volume/dimension is above an indicated threshold, is below an indicated threshold if an object RCS or average RCS or a conditional RCS (RCS with respect to a specific angle) is below an indicated threshold or above an indicated threshold or a combination of one or multiple of the mentioned criteria), e.g., upon receiving a sensing request within an area of interest by the SF, the SF determines transmitting a paging message to the said area of interest for discovery of the known UEs as physical objects, indicating knowledge of the RCS information and a minimum threshold of the RCS value as the suitability criteria; (k) supported non-3GPP sensing capability (e.g., if UE has access to measurement reading of a pressure, camera, LIDAR sensor, automotive radar, WiFi sensing, etc., may include indication of a sensor type, wherein the sensor types/IDs may be known in the application domain and/or may be specified by the 3GPP).

In some embodiments, one or multiple of the above criteria or a combination of multiple criteria are indicated (separately or as a combined indication) via an index from a codebook, wherein the codebook includes different combinations of the above suitability criteria. Example of the codebook is depicted as follows:

| Idx. | Suitability criteria |
|---|---|
| 0 | Supporting sensing reception and time/doppler-difference |
| | measurements according to a DL reference when in the RRC |
| | CONNECTED state |
| 1 | Supporting sensing reception and time/doppler-difference |
| | measurements according to a DL reference when in the RRC |
| | INACTIVE and IDLE state |
| 2 | Located within 10 meter radius of a location [e.g., to be |
| | obtained within the same paging message or via an indicated |
| | separate DL resource] |
| 3 | Supporting sensing transmission when in the RRC CONNECTED |
| | state |
| 4 | If an RSRP measurement according to a Configuration [e.g., |
| | may be obtained within the same paging message or via an |
| | indicated separate DL resource] is above an indicated threshold |
| . . . | . . . |

Upon reception of the above index, the UE may determine sensing suitability and/or decode other information elements of the DL channels to detect further suitability criteria and/or measurement configurations.

In one embodiment, upon determination of one or more suitability criteria and/or obtaining RAT-dependent and/or RAT independent sensing data, the UE determines to store the obtained sensing data, upon the UE satisfying some criteria, e.g., a buffer size for the stored data is reached, and the UE requests to obtain UL synchronization, e.g., via an RRC resume/connect request. In another example, the UE transmits its data to the network. The stored data is communicated by the paged sensing UE in response to the UE being transferred to the connected state.

In one embodiment, the new paging may include an application ID associated with a sensing task/operation, e.g., when UEs support a V2X sensing application, or a pre-defined sensing application, e.g., an application to collect temperature reading of the environment, or to collect and/or share a pre-defined non-3GPP sensing data.

In one embodiment, the new paging may include a sensing measurement configuration, which may include a sensing measurement object that indicates the frequency/time location and subcarrier spacing of reference signals to be measured. In one embodiment, the sensing measurement configuration includes a reporting configuration that includes a list of reporting configurations where there can be one or multiple reporting configurations per measurement object.

A measurement reporting configuration may include a reporting criterion that triggers the UE to send a measurement report. This can either be periodical or a single event description and may further indicate if the UE needs to report the measurement immediately i.e., as soon as the reporting criterion is met, by transitioning to RRC Connected state; or the UE may log the measurement results and provide them later when transitioning to RRC Connected for same or different reason. In some implementations, indication of UE may log/store the obtained measurement further accompanied with a memory/measurement volume threshold (upon reaching the indicated threshold the UE shall report the logged measurements or start transitioning to the RRC connected state), a queueing time threshold (upon reaching the indicated queueing time the UE shall report the logged measurements, start transitioning to the RRC connected state).

The measurement reporting configuration may include an RS type/sensing signal type/configuration. The RS and/or the parameters define a configuration of the RS that the UE uses for beam and cell measurement results (e.g., SS/PBCH block or CSI-RS or PRS) and/or configuration of a sensing signal according to which the UE performs a configured sensing measurement.

The measurement reporting configuration may include a reporting format and/or content, which may include the quantities per cell and per beam that the UE includes in the measurement report (e.g., RSRP) and other associated information such as the maximum number of cells and the maximum number of beams per cell to report. In some embodiments, the reporting further comprising sensing measurements, e.g., reporting time of arrival (ToA)/time of flight (ToF), doppler shift, RSRPP, or the like, of the one or multiple detected paths associated to a sensing target and/or sensing target area.

In one embodiment, the sensing measurement configuration includes measurement identities, which, for measurement reporting, includes a list of measurement identities where each measurement identity links one measurement object with one reporting configuration.

In one embodiment, the sensing measurement configuration includes quantity configurations that define the measurement filtering configuration used for all event evaluation and related reporting, and for periodical reporting of that measurement. In some embodiments, the measurement quantity further comprises sensing measurement type/configurations, e.g., reporting ToA/ToF, doppler shift, RSRPP, or the like, of the one or multiple detected paths associated with a sensing target and/or sensing target area.

In one embodiment, the new paging includes a required sensing quality of service and a required role, e.g., sensing transmitter, receiver or both, owner of sensing operation, or the like).

In one embodiment, the sensing configuration (or subset of parameters within the sensing configuration of a UE) can also be indicated in the new paging message as an index. The configuration corresponding to the index values can be (pre)configured to the UE or can be broadcasted e.g., in a new Sensing System Information Broadcast message, periodically or on-demand.

In some embodiments, upon satisfaction of one or multiple of the suitability criteria received as part of a paging message, an RRC Idle or inactive UE may determine to perform transitioning to the RRC connected state, a sensing operation/measurement based on a configuration embedded within the Paging message (e.g., while maintaining the same RRC state), storing obtained sensing measurements according to the configuration embedded within the paging message/PE, report (as part of the RRC resume message or via UL transmission after connected state) the determined sensing suitability according to the configuration embedded within the sensing message, and/or reporting (e.g., as part of the RRC resume message or via UL transmission after connected state) the obtained sensing measurement data according to the configuration embedded within the sensing message, or a combination thereof.

In one embodiment, the sensing measurements of the UE (while in inactive/idle state) include measuring and/or storing RSRPP of an indicated path, an angle difference of a path (to a reference path), delay difference of a path (to a reference path), or the like, reported/measured under the condition that the UE has detected a path according to the received configuration.

In some embodiments, upon determination of the suitability criteria embedded within the paging message/PE, the UE transitions to the RRC connected state and receive further configurations for sensing measurement and reporting. In some other embodiments, the sensing measurement and reporting are performed, at least in part, based on the configuration information included in the paging message/PE.

In some embodiments, the UE sends a request to transition to the RRC connected state (e.g., via rrcResumeRequest or rrcResumeRequest1) where the request message further includes an indication of the reason for transitioning to the connected state, e.g., the received one or multiple paging messages for sensing according to which the UE requests to transition to the connected state; a suitability indication of the UE, e.g., with indication of one or multiple criteria indicated within the paging message, via one or more index of the suitability/capability table; a sensing data availability, e.g., upon obtaining 3GPP sensing measurements and/or non-3GPP sensing data; and/or a status of a buffer for storing sensing data, e.g., if the buffer is full, amount of data and/or number of sensing data points/measurements stored in the buffer, the storage time/age of the sensing information stored in the buffer, or the like.

In some embodiments, upon determination of the suitability criteria embedded within the paging message/PE, the UE may ignore the paging identities included in the paging message, if any. The new paging (sensing paging) may be performed on new paging occasions calculated using a set of known or specified UE identities, not related to a particular UE's identity. The POs for new paging can be fixed and the UEs may need to monitor the new POs in addition to their own POs calculated, e.g., using 3GPP TS 38.304 (incorporated herein by reference). In one embodiment, the new POs are calculated using 3GPP TS 38.304 based on the UE's identity. Here, the paging message contains one indication seeking UEs that may help in a sensing session.

In some embodiments, different parts of a sensing paging message (e.g., one or multiple suitability criteria and/or measurements configuration and/or reporting configuration) may be indicated separately via paging messages of one or multiple sensing paging occasions.

For example, a first part of the paging message/suitability criteria and/or measurements configuration and/or reporting configuration is indicated via the paging DCI type 1_0 of the first occasion (via the DCI itself or the PDSCH resources indicated within the said DCI) and a second part of the paging message/suitability criteria and/or measurements configuration and/or reporting configuration is indicated via the paging DCI type 1_0 of the second occasion. In some such implementations, the second PO is not a paging normal monitoring occasion and is indicated within the first PO, and the second PO and/or the paging message of the second PO is decoded/monitored if a given criteria (indicated within the paging DCI type1_0 of the first occasion) is satisfied.

In some embodiments, different parts of a sensing paging message (e.g., one or multiple suitability criteria and/or measurements configuration and/or reporting configuration) may be indicated separately via a DCI message of a sensing paging carried within PDCCH DCI format 1_0 (with CRC scrambled with a sensing P-RNTI). For example, as content of a short message embedded within the DCI.

In some embodiments, different parts of a sensing paging message (e.g., one or multiple suitability criteria and/or measurements configuration and/or reporting configuration) may be indicated separately via RRC paging message.

In some embodiments, different parts of a sensing paging message (e.g., one or multiple suitability criteria and/or measurements configuration and/or reporting configuration) may be indicated separately via an additional PDSCH scheduled message (e.g., time-frequency resources defined within the first paging message, e.g., DCI or the RRC paging message, and decoded upon satisfaction of the criteria indicated within the said first paging message) carrying an extension of a sensing paging.

In some embodiments, different parts of a sensing paging message (e.g., one or multiple suitability criteria and/or measurements configuration and/or reporting configuration) may be indicated separately via a paging message of multiple sensing paging with different P-RNTIs, For example, UEs with different sensing technology types or belonging to different sensing capability/security/trust groups may be configured/indicated to decode/monitor the DCI with different sensing P-RNTI (s-P-RNTI), and wherein each paging corresponding to a s-P-RNTI is defined with different paging monitoring occasions for the UEs capable of.

In some embodiments, a first set of (e.g., more general) suitability criteria are included in the DCI message and/or the RRC paging message (e.g., if UE supports sensing with a specific role of sensing transmitter, sensing receiver, joint sensing transmission and reception, providing non-3GPP sensing, or a combination thereof) and in response to a UE determining suitability based on the first suitability criteria, the UE may further process a message/information containing a second suitability criteria and/or a sensing measurement and/or reporting configuration (e.g., if the UE supports a specific 3GPP sensing measurement method/type (time/delay measurement, doppler meas. etc.), measurement accuracy/periodicity, non-3GPP sensing data/measurement type), measurement configuration (e.g., configuration of a sensing signal and/or sensing measurement type of an RSRPP, RSTD, etc. associated to a sensing target object), reporting configuration or a combination thereof.

In some embodiments, the second suitability criteria, a sensing measurement, and/or reporting configuration is embedded within the same DCI containing the first suitability criteria but within a separate message field, within a separate DCI 1_0 with CRC scrambled with sensing P-RNTI received at a different occasion, within the paging extension of RRC paging message, or within a scheduled PDSCH resources defined in the received paging DCI or within a separate PDSCH time/frequency resource scheduled/indicated within the DCI paging message.

In one example, the network illuminates an area of interest (e.g., a road segment) to be monitored via radio sensing for presence of vehicles and/or pedestrians, e.g., by transmitting a DL or SL sensing signal (e.g., a PRS/SRS/CSI-RS, etc.). Moreover, the network sends a sensing paging as described above, within the area of interest to be monitored with a sensing P-RNTI, where the sensing paging includes an indication of 3GPP radio sensing capability as sensing Rx, capability of sensing measurements including power (RSRPP), angle, time, doppler, or a combination thereof, as sensing measurement method, within the paging DCI and/or the paging message. Moreover, the sensing measurement configuration (including parameters defining the sensing signal and the sensing measurements to be reported and reporting configuration or a combination thereof) is provided in a multicast or broadcast message with the time-frequency resources and parameters for decoding the said message provided within the same paging DCI or paging RRC message indicated within the paging DCI or an indicated separate paging DCI. Upon a UE reception of the said paging DCI and/or the paging message and determination of suitability of the UE for the indicated sensing capabilities, the UE shall decode the message within the indicated time-frequency resources to receive the sensing measurement configuration and to perform the sensing measurement and reporting according to the received configuration.

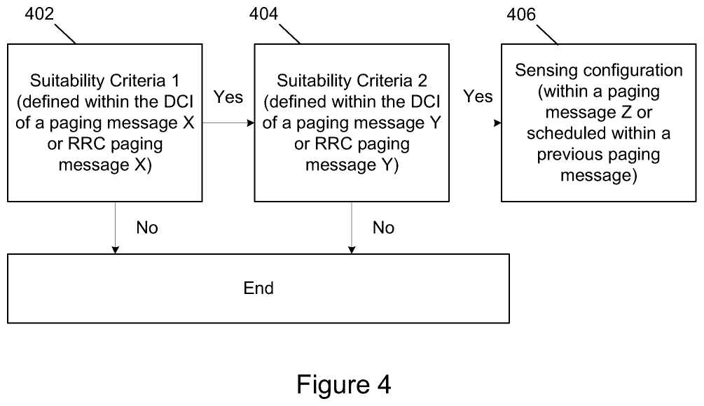

FIG. 4 depicts an example sequence of multiple suitability criteria 402-406 received and processed separately by the UE via information of paging messages X, Y, or the like, where the paging messages X, Y, or the like, may be the same (wherein the different suitability criteria is received via different information fields), or different (e.g., at different paging occasions). Upon satisfaction of the multiple criteria, the UE may send a request for transferring to RRC active state and receive further configurations for sensing operation, or further receive configuration information via a paging message Z (similar or different than messages X, Y) or via a scheduled PDSCH message within a previous paging message (e.g., defined within DCI of the paging message X). In some embodiments, the said configuration includes 3GPP sensing radio measurements, or non-3GPP sensing data collection and/or reporting configuration (type of the non-3GPP data, area of observation, buffer size before reporting, data format/type/resolution, and reporting configuration upon transitioning to RRC active state etc., or a combination thereof).

In some embodiments, the UE is only requested to monitor a PO/decode and process DCI with a sensing P-RNTI at a specific time occasion or process a message comprising extended information if the said criteria (indicated within a previous paging or pre-configured) is met. In one example implementation, upon UE determining that an indicated one or more of the suitability criteria is not satisfied, the UE shall monitor the PO with a reduced frequency (as indicated via a DCI or within a broadcast message, within a paging message or pre-configured) and may ignore the PO for an indicated time window (as indicated via a DCI or within a broadcast message, within a paging message or pre-configured).

In one embodiment, the network indicates to the UEs one or more of time occasion patterns corresponding to one or more of suitability criteria, such that the UEs satisfying the criteria shall monitor/decode the corresponding paging occasion (e.g., paging messages containing a suitability check with the criteria may be transmitted via the indicated occasion/time pattern) and/or the UEs not satisfying the criteria are not required to monitor/decode the corresponding paging occasion (e.g., the indicated occasion/time pattern will be used for the UEs satisfying the said criteria).

In some embodiments, the network indicates to the UEs of the mapping of the suitability criteria to the POs is indicated, for example, pre-configured as part of a broadcast or multi-cast or a dedicated message received by the UE (e.g., dedicated DCI or a group common DCI) and/or within a sensing paging message, e.g., an indication that the described criteria correspond to an indicated paging time/occasion pattern.

In one embodiment, the network may page UEs capable of non-3GPP sensing of a Loci in a first sensing paging occasion e.g., corresponding to a first time/occasion pattern (e.g., the paging message of the said occasion may include suitability criteria of providing non-3GPP sensing data and/or a non-3GPP sensing data type), and the UEs capable of operating as 3GPP sensing receiver/processor in a same or different Loci via a second sensing paging occasion e.g., corresponding to a first time/occasion pattern.

In one example, when a UE is not in a stationary condition, it is indicated or pre-configured to monitor or not to monitor a first time pattern for sensing paging occasions (e.g., a periodicity, initial time, window duration or combination thereof defining a time pattern for which UE is not required to monitor a pre-configured paging occasion pattern) and if a UE is not capable of 3GPP sensing measurements (but may collect non 3GPP sensing measurement), then it is indicated or preconfigured to not monitor (or monitor).

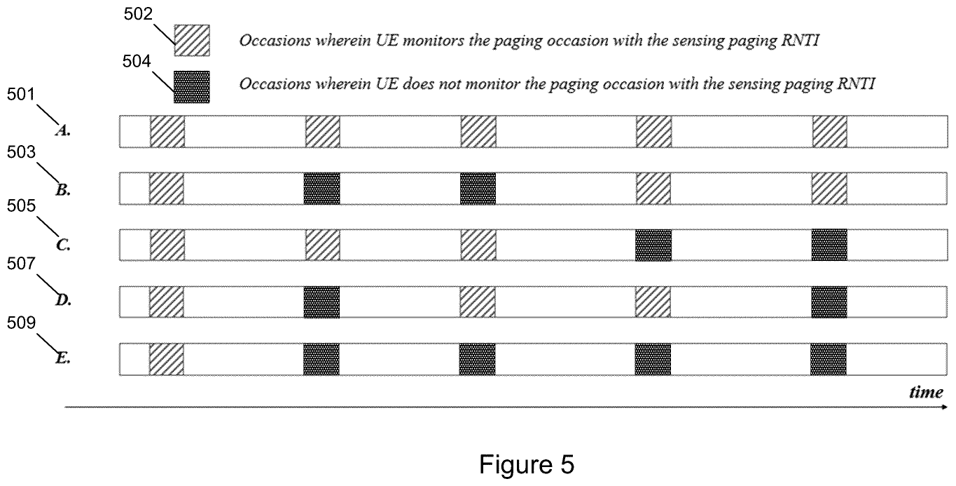

FIG. 5 shows an example of monitoring paging occasions for sensing paging of UEs with different conditions. Striped marks 502 represent the occasions that are monitored and stippled marks 504 represents the occasions for which the UE is not required to monitor/decode the paging message with the indicated paging RNTI for sensing. In particular, A 501 represents the POs in which a paging message can be sent, and a UE may monitor the messages via the indicated paging RNTI for sensing.

In one embodiment, at B 503, the striped marks 502 represent the POs in which the network may page UEs that are not capable of sensing signal transmission but may be relevant or support sensing operations in other ways, wherein the stippled marks 504 represent the occasions where only UEs will be called for with the capability of acting as a sensing transmitter. Hence, the UEs that are not capable of acting as a sensing transmitter are not required to monitor the occasions marked with red color.

At C 505, in one embodiment, the striped marks 502 represent the POs in which the network may page UEs that are not capable of sensing signal reception/measurement/processing, but may be relevant or support sensing operation in other ways, wherein the stippled marks 504 represent the occasions wherein the UEs will be called for with the capability of acting as a sensing receiver.

In one embodiment, at D 507, the striped marks 502 represent the POs in which the network may page a UE that is not static (e.g. is moving), but may be relevant or support sensing operation, wherein the stippled marks represent the occasions wherein the UEs will be called for with a stationary condition.

At E 509, in one embodiment, the striped occasions 502 represent the POs in which the network may page UEs that do not support 3GPP radio sensing but may be relevant to support sensing operation (e.g., by providing non-3GPP sensing data), wherein the stippled marks represent the occasions wherein the UEs will be paged that support 3GPP radio sensing.

In some embodiments (within the example in FIG. 5) the depicted time axis may be frequency access, e.g., the paging resource elements (Res) may be divided based on the UE capabilities such that the UE is only needed to monitor the REs/RBs that map to the relevant capabilities.

In some embodiments, the UE informs the network (e.g., upon request of the network) of the paging occasions that the UE does not monitor, e.g., according to a pre-configured policy for monitoring of sensing paging occasions. In some such embodiments, the UE informing the network is done explicitly, e.g., the time pattern/time pattern IDs that UE may not monitor the PO according to an a priori known or indicated policy, or done implicitly, by updating the network of the capability condition/information of the UE. In some embodiments, the UE indicates to the network of the sensing capabilities when at RRC active, RRC inactive, RRC idle states. As such, the sensing POs of the UE are indicated via dedicated signaling to the UE by the network, based on the network time pattern of sensing paging occasions for different reasons and the received UE capabilities.

In some embodiments, a paging of the same or different RNTI (e.g., a PI-RNTI) is transmitted to inform a group of UEs for updating their POs, e.g., as an indication of monitoring of the POs with an indicated periodicity or time pattern and/or for an indicated period of time.

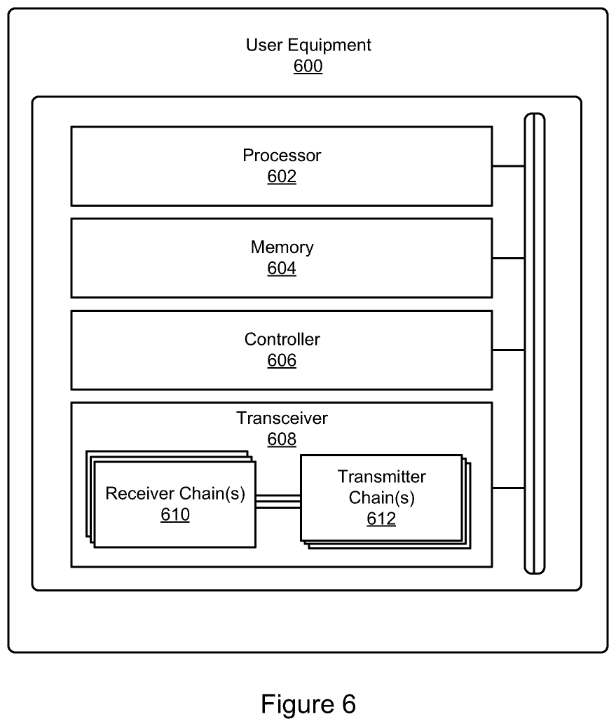

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions that, when executed by the processor 602, cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means to receive a P-RNTI for receiving a paging message associated with sensing, receive information associated with POs to be monitored that are associated with the P-RNTI, receive a paging message based on the received P-RNTI and the information associated with the POs, determine sensing suitability of the UE based on the received paging message, and transmit a request to transfer to RRC connected state based on the determined sensing suitability.

In one embodiment, the P-RNTI or the information associated with the POs is received responsive to transmitting capability information for the UE 600.

In one embodiment, the paging message comprises at least one sensing suitability condition for use in determining the sensing suitability of the UE 600.

In one embodiment, the sensing suitability condition comprises at least one of a loci and a radius from the loci, a stationary condition, a radio sensing capability, a battery threshold, a clock synchronization with respect to downlink of the serving cell or GNSS, whether the processor can fulfill sensing quality, whether the processor has information about characteristics associated with physical objects around the processor, supported non-3GPP sensing capability, an application identifier associated with a sensing task/operation, or a combination thereof.

In one embodiment, the sensing suitability condition is indicated as an index of a codebook, the codebook preconfigured with different combinations of sensing suitability conditions.

In one embodiment, the at least one processor 602 is configured to cause the UE 600 to receive the sensing suitability condition at different information parts, the different information parts comprising a paging message of at least one sensing PO, a DCI message of a sensing paging carried within PDCCH DCI format 1_0, an RRC paging message, a PDSCH scheduled message, or a combination thereof.

In one embodiment, wherein a first part of the sensing suitability condition is received within a first information part and a second part of the sensing suitability condition is received within a second information part.

In one embodiment, the information of the second information part is received and processed in response to satisfaction of the sensing suitability condition within the first information part.

In one embodiment, the paging message comprises a measurement configuration for performing measurements in an RRC IDLE and/or RRC INACTIVE state.

In one embodiment, the measurement configuration comprises a measurement of RSRPP, RSTD, AoA, ZoA, or a combination thereof, for a detected path relative to an indicated reference.

In one embodiment, the measurement configuration comprises a type, a format, a resolution, a time-window, or a combination thereof, for an available RAT-independent sensor.

In one embodiment, the suitability condition is based on a result of a measurement or a measurement performed in an RRC IDLE or RRC INACTIVE state.

In one embodiment, the at least one processor 602 is configured to cause the UE 600 to determine the PO based at least in part on the information associated with the PO.

In one embodiment, in response to the UE 600 not comprising a sensing capability, the at least one processor 602 is configured to cause the UE 600 to not monitor POs associated with the sensing capability.

In one embodiment, in response to the UE 600 comprising a sensing capability, the at least one processor 602 is configured to cause the UE 600 to monitor POs associated with the sensing capability.

In one embodiment, the information associated with the POs is received via a broadcast message or a multicast message, and wherein the information associated with the POs comprises at least one PO to be monitored and at least one PO to be ignored in response to a criterion defined within the information being satisfied.

In one embodiment, the at least one processor 602 is configured to cause the UE 600 to receive an indication and/or configuration information for storing obtained sensing data while in an RRC INACTIVE or RRC IDLE state, and store the obtained sensing data according to the received indication or configuration.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

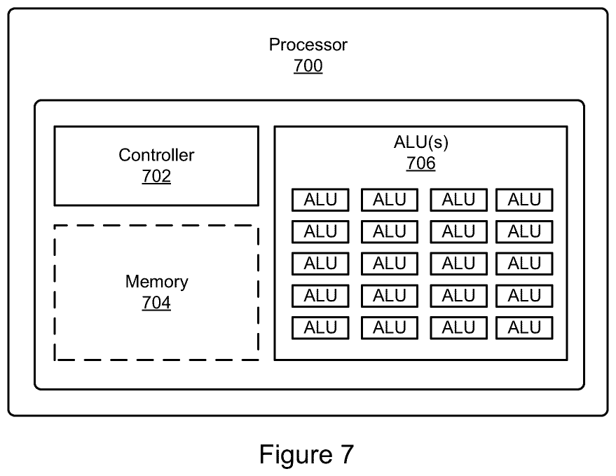

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more

ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means to receive a P-RNTI for receiving a paging message associated with sensing, receive information associated with POs to be monitored that are associated with the P-RNTI, receive a paging message based on the received P-RNTI and the information associated with the POs, determine sensing suitability of the UE based on the received paging message, and transmit a request to transfer to RRC connected state based on the determined sensing suitability.

In one embodiment, the P-RNTI or the information associated with the POs is received responsive to transmitting capability information for the processor 700.

In one embodiment, the paging message comprises at least one sensing suitability condition for use in determining the sensing suitability of the processor 700.

In one embodiment, the sensing suitability condition comprises at least one of a loci and a radius from the loci, a stationary condition, a radio sensing capability, a battery threshold, a clock synchronization with respect to downlink of the serving cell or GNSS, whether the processor can fulfill sensing quality, whether the processor has information about characteristics associated with physical objects around the processor, supported non-3GPP sensing capability, an application identifier associated with a sensing task/operation, or a combination thereof.

In one embodiment, the sensing suitability condition is indicated as an index of a codebook, the codebook preconfigured with different combinations of sensing suitability conditions.

In one embodiment, the at least one controller 702 is configured to cause the processor 700 to receive the sensing suitability condition at different information parts, the different information parts comprising a paging message of at least one sensing PO, a DCI message of a sensing paging carried within PDCCH DCI format 1_0, an RRC paging message, a PDSCH scheduled message, or a combination thereof.

In one embodiment, wherein a first part of the sensing suitability condition is received within a first information part and a second part of the sensing suitability condition is received within a second information part.

In one embodiment, the information of the second information part is received and processed in response to satisfaction of the sensing suitability condition within the first information part.

In one embodiment, the paging message comprises a measurement configuration for performing measurements in an RRC IDLE and/or RRC INACTIVE state.

In one embodiment, the measurement configuration comprises a measurement of RSRPP, RSTD, AoA, ZoA, or a combination thereof, for a detected path relative to an indicated reference.

In one embodiment, the measurement configuration comprises a type, a format, a resolution, a time-window, or a combination thereof, for an available RAT-independent sensor.

In one embodiment, the suitability condition is based on a result of a measurement or a measurement performed in an RRC IDLE or RRC INACTIVE state.

In one embodiment, the at least one controller 702 is configured to cause the processor 700 to determine the PO based at least in part on the information associated with the PO.

In one embodiment, in response to the processor 700 not comprising a sensing capability, the at least one controller 702 is configured to cause the processor 700 to not monitor POs associated with the sensing capability.

In one embodiment, in response to the processor 700 comprising a sensing capability, the at least one controller 702 is configured to cause the processor 700 to monitor POs associated with the sensing capability.

In one embodiment, the information associated with the POs is received via a broadcast message or a multicast message, and wherein the information associated with the POs comprises at least one PO to be monitored and at least one PO to be ignored in response to a criterion defined within the information being satisfied.

In one embodiment, the at least one controller 702 is configured to cause the processor 700 to receive an indication and/or configuration information for storing obtained sensing data while in an RRC INACTIVE or RRC IDLE state, and store the obtained sensing data according to the received indication or configuration.

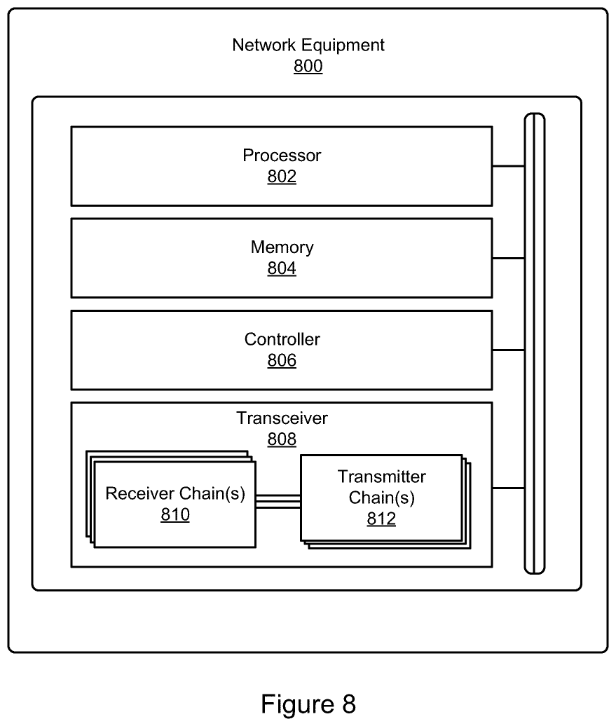

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions that, when executed by the processor 802, cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means to receive a request for at least one sensing task, determine, in response to the request, a paging message, the paging message comprising suitability criteria for sensing, a sensing measurement configuration, or a combination thereof, transmit the determined paging message, and receive a response comprising a sensing suitability, sensing data availability, or a combination thereof.

The NE 800 may be configured to support a means to determine that at least one sensing task is associated with one or more sensing-capable devices in RRC INACTIVE or RRC IDLE state and send a paging message to identify the one or more of sensing-capable device in RRC INACTIVE or RRC IDLE state.

In one embodiment, determining the paging message is based on sensing KPIs of the at least one sensing task, an availability of TRPs or RAN node capabilities for a related area of interest for sensing, a recommendation of a second NE, a security requirement of the at least one sensing task, or a combination thereof.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

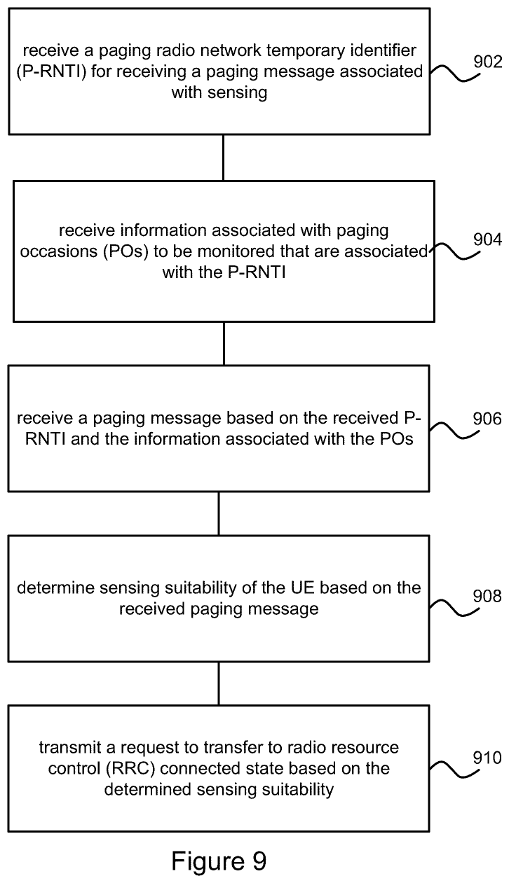

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may receive a P-RNTI for receiving a paging message associated with sensing. The operations of 902 may be performed in accordance with examples as described herein. In some implementations, aspects of the operations of 902 may be performed by a UE as described with reference to FIG. 6.

At 904, the method may receive information associated with POs to be monitored that are associated with the P-RNTI. The operations of 904 may be performed in accordance with examples as described herein. In some implementations, aspects of the operations of 904 may be performed by a UE as described with reference to FIG. 6.

At 906, the method may receive a paging message based on the received P-RNTI and the information associated with the POs. The operations of 906 may be performed in accordance with examples as described herein. In some implementations, aspects of the operations of 906 may be performed a UE as described with reference to FIG. 6.

At 908, the method may determine sensing suitability of the UE based on the received paging message. The operations of 908 may be performed in accordance with examples as described herein. In some implementations, aspects of the operations of 908 may be performed a UE as described with reference to FIG. 6.

At 910, the method may transmit a request to transfer to RRC connected state based on the determined sensing suitability. The operations of 910 may be performed in accordance with examples as described herein. In some implementations, aspects of the operations of 910 may be performed a UE as described with reference to FIG. 6.

It should be noted that the method described herein describes A possible implementation, and that the operations and the steps may be rearranged or otherwise modified and that other implementations are possible.

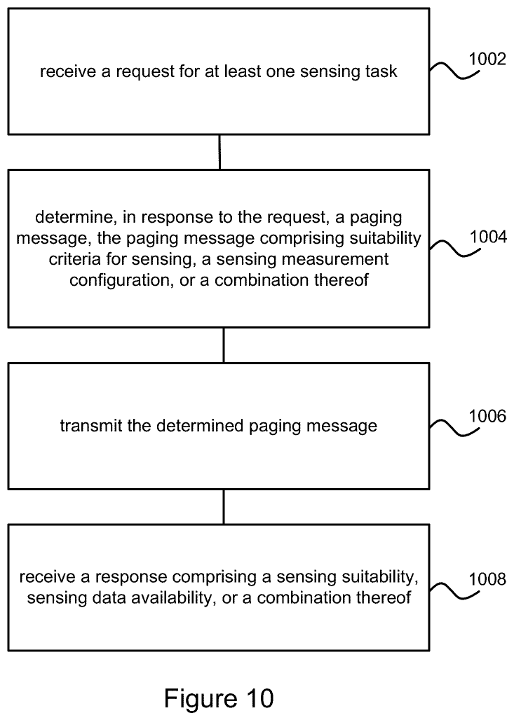

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions.

At 1002, the method may receive a request for at least one sensing task. The operations of 1002 may be performed in accordance with examples as described herein. In some implementations, aspects of the operations of 1002 may be performed by a NE as described with reference to FIG. 8.

At 1004, the method may determine, in response to the request, a paging message, the paging message comprising suitability criteria for sensing, a sensing measurement configuration, or a combination thereof. The operations of 1004 may be performed in accordance with examples as described herein. In some implementations, aspects of the operations of 1004 may be performed by a NE as described with reference to FIG. 8.

At 1006, the method may transmit the determined paging message. The operations of 1006 may be performed in accordance with examples as described herein. In some implementations, aspects of the operations of 1006 may be performed a NE as described with reference to FIG. 8.

At 1008, the method may receive a response comprising a sensing suitability, sensing data availability, or a combination thereof. The operations of 1008 may be performed in accordance with examples as described herein. In some implementations, aspects of the operations of 1008 may be performed a NE as described with reference to FIG. 8.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a paging radio network temporary identifier (P-RNTI) for receiving a paging message associated with sensing;
receive information associated with paging occasions (POs) to be monitored that are associated with the P-RNTI;
receive a paging message based on the received P-RNTI and the information associated with the POs;
determine sensing suitability of the UE based on the received paging message; and
transmit a request to transfer to radio resource control (RRC) connected state based on the determined sensing suitability.

2. The UE of claim 1, wherein the P-RNTI or the information associated with the POs is received responsive to transmitting capability information for the UE.

3. The UE of claim 1, wherein the paging message comprises at least one sensing suitability condition for use in determining the sensing suitability of the UE.

4. The UE of claim 3, wherein the sensing suitability condition comprises at least one of a loci and a radius from the loci, a stationary condition, a radio sensing capability, a battery threshold, a clock synchronization with respect to downlink of the serving cell or global navigation satellite system (GNSS), whether the UE can fulfill sensing quality, whether the UE has information about characteristics associated with physical objects around the UE, supported non-3GPP sensing capability, an application identifier associated with a sensing task/operation, or a combination thereof.

5. The UE of claim 4, wherein the sensing suitability condition is indicated as an index of a codebook, the codebook preconfigured with different combinations of sensing suitability conditions.

6. The UE of claim 4, wherein the at least one processor is configured to cause the UE to receive the sensing suitability condition at different information parts, the different information parts comprising a paging message of at least one sensing PO, a downlink control information (DCI) message of a sensing paging carried within physical downlink control channel (PDCCH) DCI format 1_0, an RRC paging message, a physical downlink shared channel (PDSCH) scheduled message, or a combination thereof.

7. The UE of claim 6, wherein a first part of the sensing suitability condition is received within a first information part and a second part of the sensing suitability condition is received within a second information part.

8. The UE of claim 7, wherein the information of the second information part is received and processed in response to satisfaction of the sensing suitability condition within the first information part.

9. The UE of claim 1, wherein the paging message comprises a measurement configuration for performing measurements in an RRC IDLE and/or RRC INACTIVE state.

10. The UE of claim 9, wherein the measurement configuration comprises a measurement of reference signal received power path (RSRPP), reference signal time difference (RSTD), angle of arrival (AoA), zenith of arrival (ZoA), or a combination thereof, for a detected path relative to an indicated reference.

11. The UE of claim 9, wherein the measurement configuration comprises a type, a format, a resolution, a time-window, or a combination thereof, for an available radio access technology (RAT)-independent sensor.

12. The UE of claim 11, wherein the suitability condition is based on a result of a measurement or a measurement performed in an RRC IDLE or RRC INACTIVE state.

13. The UE of claim 1, wherein the at least one processor is configured to cause the UE to determine the PO based at least in part on the information associated with the PO.

14. The UE of claim 13, wherein, in response to the UE not comprising a sensing capability, the at least one processor is configured to cause the UE to not monitor POs associated with the sensing capability.

15. The UE of claim 13, wherein, in response to the UE comprising a sensing capability, the at least one processor is configured to cause the UE to monitor POs associated with the sensing capability.

16. The UE of claim 13, wherein the information associated with the POs is received via a broadcast message or a multicast message, and wherein the information associated with the POs comprises at least one PO to be monitored and at least one PO to be ignored in response to a criterion defined within the information being satisfied.

17. The UE of claim 1, wherein the at least one processor is configured to cause the UE to receive an indication and/or configuration information for storing obtained sensing data while in an RRC INACTIVE or RRC IDLE state and store the obtained sensing data according to the received indication or configuration.

18. A processor for wireless communication, comprising:
at least one controller coupled with at least one memory and configured to cause the processor to:
receive a paging radio network temporary identifier (P-RNTI) for receiving a paging message associated with sensing;
receive information associated with paging occasions (POs) to be monitored that are associated with the P-RNTI;
receive a paging message based on the received P-RNTI and the information associated with the POs;
determine sensing suitability of the UE based on the received paging message; and
transmit a request to transfer to radio resource control (RRC) connected state based on the determined sensing suitability.

19. A method performed by a user equipment (UE), the method comprising:
receiving a paging radio network temporary identifier (P-RNTI) for receiving a paging message associated with sensing;
receiving information associated with paging occasions (POs) to be monitored that are associated with the P-RNTI;
receiving a paging message based on the received P-RNTI and the information associated with the POs;
determining sensing suitability of the UE based on the received paging message; and
transmitting a request to transfer to radio resource control (RRC) connected state based on the determined sensing suitability.

20. A network equipment (NE) for wireless communication, comprising:
at least one memory; and
at least one processor coupled with the at least one memory and configured to cause the NE to:
receive a request for at least one sensing task;
determine, in response to the request, a paging message, the paging message comprising suitability criteria for sensing, a sensing measurement configuration, or a combination thereof;
transmit the determined paging message; and
receive a response comprising a sensing suitability, sensing data availability, or a combination thereof.
